(19) United States
(12) Patent Application Publication
(10) Pub. No.: US 2018/0363839 A1
(43) Pub. Date: Dec. 20, 2018

(54) Beverage Clip

(71) Applicant: O2COOL, LLC, Chicago, IL (US)

(72) Inventors: Oliver Breit, Midvale Village, Discovery Bay (HK); Mak Shek Fung, Hong Kong (CN); Michael Ksiazek, Burr Ridge, IL (US); Eric F. Junkel, Mount Prospect, IL (US)

(21) Appl. No.: 15/622,381

(22) Filed: Jun. 14, 2017

(51) Int. Cl. F16M 13/02

(52) U.S. Cl. CPC F16M 13/02

(57) ABSTRACT

An apparatus for receiving a liquid container adapted and configured to be removably coupled to an object includes a first clip portion and a second clip portion pivotally coupled to one another. The first clip portion has an outer facing portion, an inner facing portion opposite the outer facing portion, a first end, and a second end. The first end has a plurality of concentric step portions consecutively positioned with increasing depth relative to the outer facing portion. The first end has a stem receiving opening and a stem receiving channel adapted and configured to allow a stem to pass into the first end and into the stem receiving opening. The second clip portion has a first end and a second end. The first end has an opening through the second clip portion and a stem receiving channel.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND

### Field of the Disclosure

The present disclosure pertains generally to a clip adapted and configured to be secured to a surface, structure, or object, and more particularly, to a clip that is further adapted and configured to receive a variety of liquid containers. For example, and without limitation, the present disclosure includes a clip configured to receive liquid containers including cups, wine glasses, and the like.

### SUMMARY

One aspect of the present disclosure is an apparatus for receiving a liquid container adapted and configured to be removably coupled to an object. The apparatus includes a first clip portion and a second clip portion. The first clip portion has an outer facing portion and an inner facing portion opposite the outer facing portion. The first clip portion has a first end and a second end opposite the first end, where the first end has a plurality of concentric step portions consecutively positioned with increasing depth relative to the outer facing portion. The plurality of concentric step portions extends around a stem receiving opening in the outer facing portion, and the first end has a stem receiving channel adapted and configured to allow a stem to pass into the first end and into the stem receiving opening. The second clip portion has an outer facing portion and an inner facing portion opposite the outer facing portion. The second clip portion has a first end and a second end opposite the first end, where the first end has a circular opening through the second clip portion. The circular opening is adapted and configured to receive a liquid container. The first end further has a stem receiving channel adapted and configured to allow a stem to pass into the first end and into the circular opening. The first clip portion and the second clip portion are pivotally coupled to one another, and the second end of the first clip portion is biased towards the second end of the second clip portion.

A further aspect of the disclosure is a method of supporting a beverage container, the method includes providing a holder having a first clip portion having an outer facing portion and an inner facing portion opposite the outer facing portion. The first clip portion has a first end and a second end opposite the first end, and the first end has a plurality of concentric step portions consecutively positioned with increasing depth relative to the outer facing portion. The plurality of concentric step portions extend around a stem receiving opening. The first end has a stem receiving channel adapted and configured to allow a stem to pass into the first end and into the stem receiving opening. A second clip portion has an outer facing portion and an inner facing portion opposite the outer facing portion. The second clip portion has a first end and a second end opposite the first end, where the first end has a circular opening through the second clip portion. The circular opening is adapted and configured to receive a liquid container. The first end further has a stem receiving channel adapted and configured to allow a stem to pass into the first end and into the circular opening. The first clip portion and the second clip portion are pivotally coupled to one another such that one or more of the first clip portion and the second clip portion are pivotable about an axis. A biasing member is adapted and configured to bias the second end of the first clip portion towards the second end of the second clip portion. The method further includes selectively orienting the holder, with the first clip portion upward for use with a stemmed container and the second clip portion upward for use with a stemless container. The method additionally includes pivoting one or more of the first clip portion and the second clip portion about the axis such that a distance between the second end of the first clip portion and the second end of the second clip portion is increased. And the method includes placing the holder relative to an object such that the object extends between the second end of the first clip portion and the second end of the second clip portion.

A further aspect of the present disclosure is an apparatus for receiving a liquid container adapted and configured to be removably coupled to an object. The apparatus includes a first clip portion and a second clip portion. The first clip portion has an outer facing portion and an inner facing portion opposite the outer facing portion. The first clip portion has a first end and a second end opposite the first end, where the first end has a stemmed container receiving member. The stemmed container receiving member extends around a stem receiving opening in the outer facing portion, and the first end has a stem receiving channel adapted and configured to allow a stem to pass into the first end and into the stem receiving opening. The second clip portion has an outer facing portion and an inner facing portion opposite the outer facing portion. The second clip portion has a first end and a second end opposite the first end, where the first end has a circular opening through the second clip portion. The circular opening is adapted and configured to receive a liquid container. The first end further has a stem receiving channel adapted and configured to allow a stem to pass into the first end and into the circular opening. The first clip portion and the second clip portion are pivotally coupled to one another, and the second end of the first clip portion is biased towards the second end of the second clip portion.

Further features and advantages of the present disclosure, as well as the structure and operation of various embodiments of the present disclosure, are described in detail below with reference to the accompanying drawings.

### BRIEF DESCRIPTION OF THE DRAWINGS

The accompanying drawings, which are incorporated in and form a part of the specification, illustrate the embodiments of the present disclosure and together with the description, serve to explain the principles of the disclosed embodiments. In the drawings:

FIG. 1 is a perspective view of an embodiment of a drink holding apparatus for receiving a liquid container, the apparatus adapted and configured to be removably coupled to an object.

FIG. 2 is a front view of the drink holder shown in FIG. 1.

FIG. 3 is a rear view of the drink holder shown in FIG. 1.

FIG. 4 is a left elevation view of the drink holder shown in FIG. 1.

FIG. 5 is a right elevation view of the drink holder shown in FIG. 1.

FIG. 6 is a top view of the drink holder shown in FIG. 1.

FIG. 7 is a bottom view of the drink holder shown in FIG. 1.

FIG. 8 is a further perspective view of the drink holder shown in FIG. 1.

FIG. 9 is a still further perspective view of the drink holder shown in FIG. 1.

FIG. 10 is a perspective view of an additional embodiment of the drink holder shown in FIG. 1.

FIG. 11 is a perspective view of a further additional embodiment of the drink holder shown in FIG. 1.

Reference numerals in the written specification and in the drawing figures indicate corresponding items.

### DETAILED DESCRIPTION OF THE PREFERRED EMBODIMENT

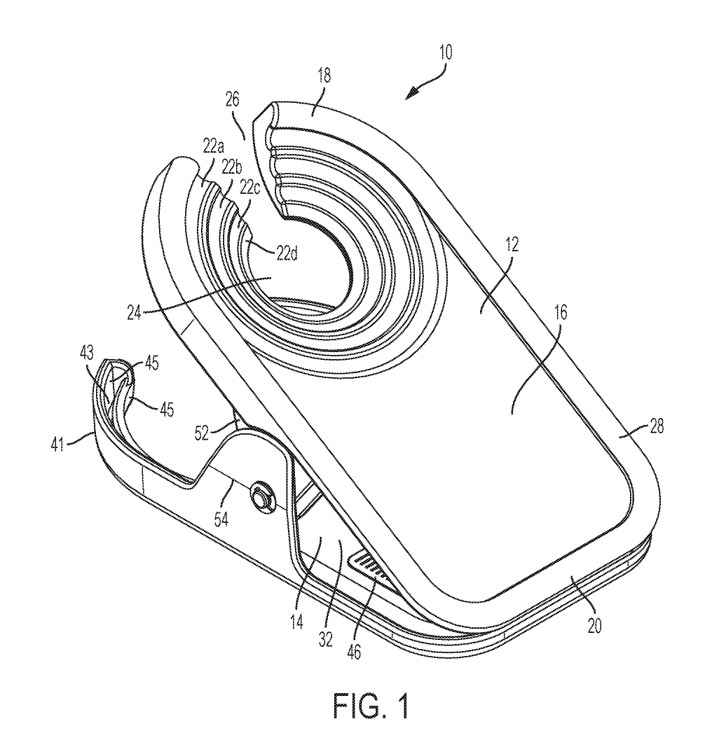

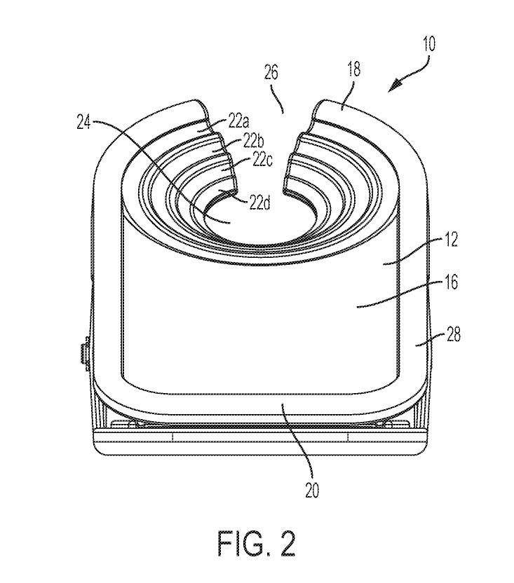

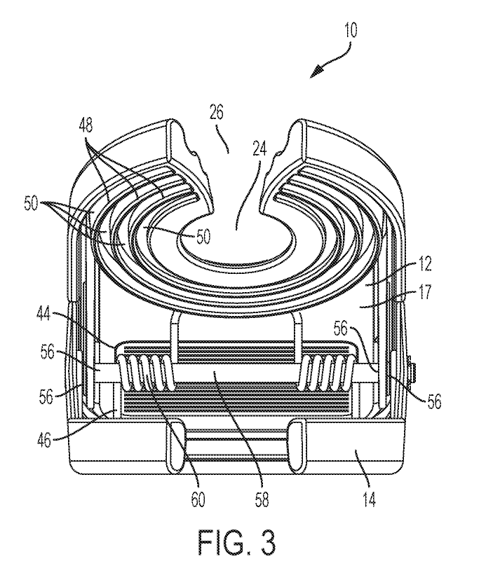

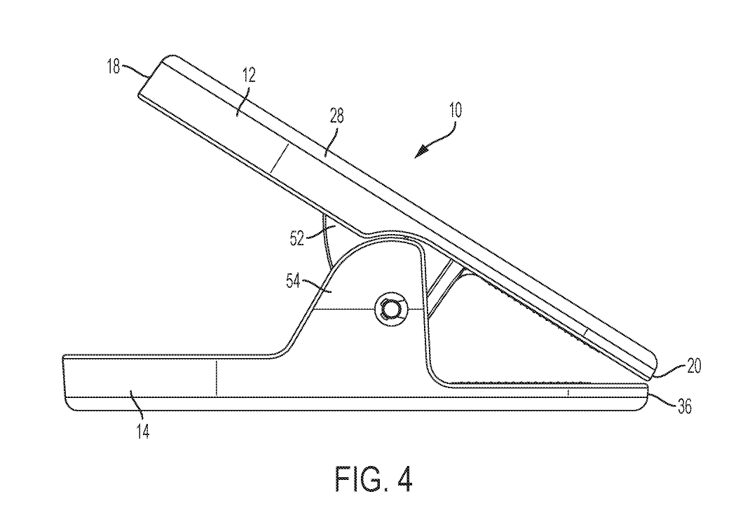

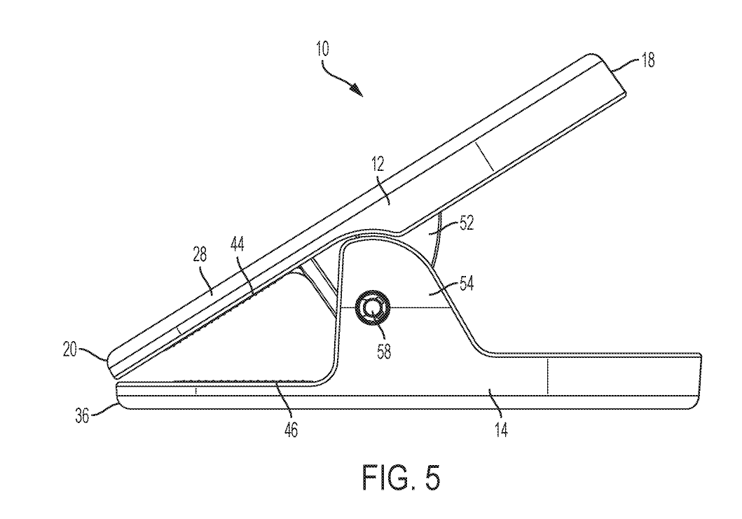

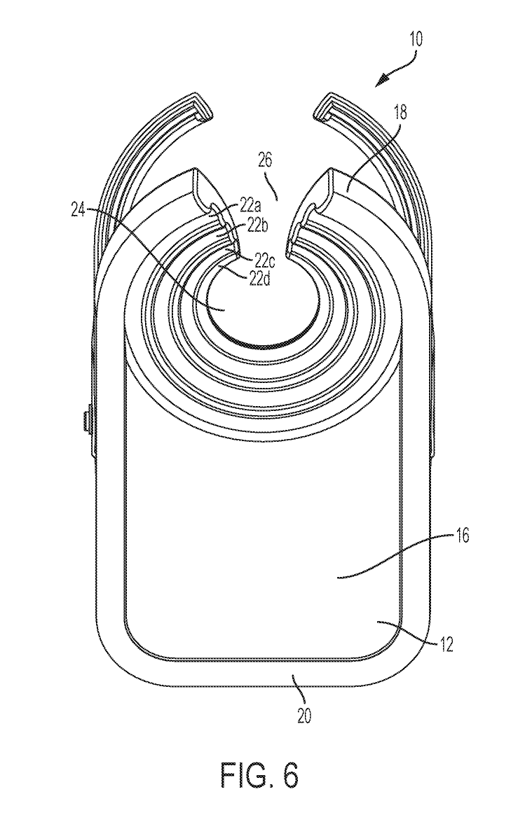

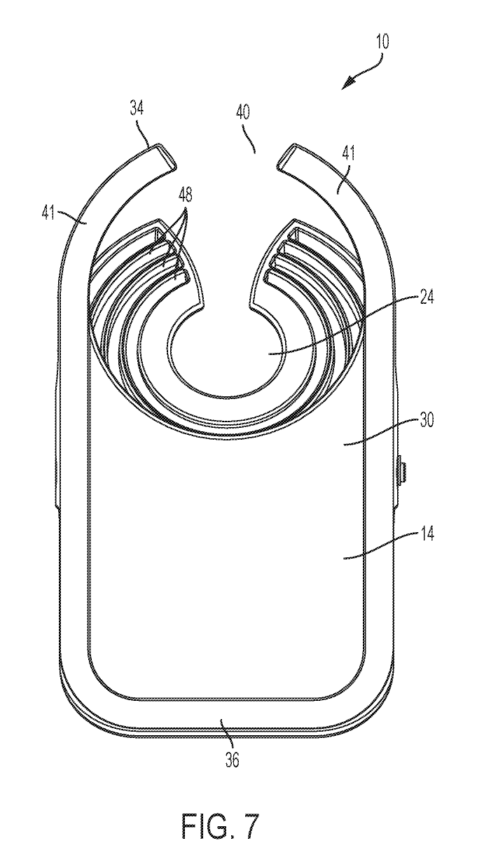

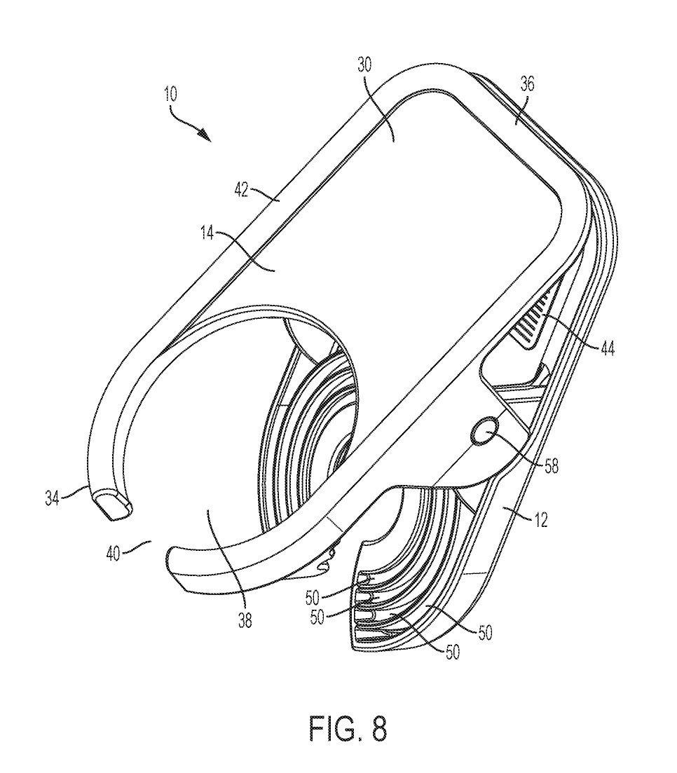

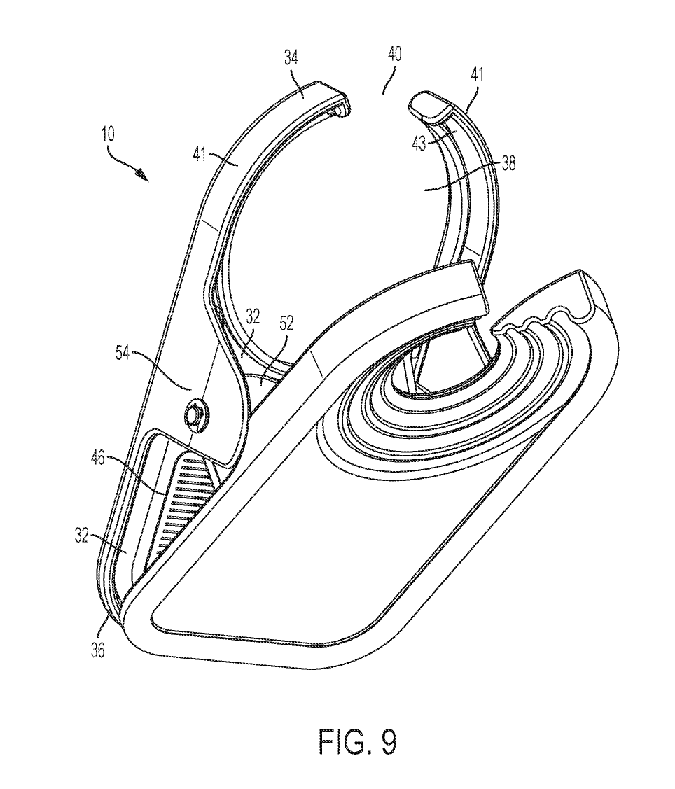

In one embodiment, as shown in FIGS. 1 through 9, a holder 10 for receiving a liquid container is adapted and configured to be removably coupled to an object. The holder 10 includes a first clip portion 12 and a second clip portion 14. The first clip portion 12 has an outer facing portion 16 and an inner facing portion 17 that is opposite the outer facing portion 16. The first clip portion 12 further has a first end 18 and a second end 20 opposite the first end 18. As used herein, the term “end” may include a portion extending inward from the extremes of the described object, portion, or the like. The first end 18 includes a plurality of concentric step portions 22. The first end 18 and the plurality of concentric step portions 22 extend around a stem receiving opening 24. The first end 18, including the plurality of concentric step portions 22, further have a stem receiving channel 26 adapted and configured to allow a stem of a liquid container to pass into the first end 18 and into the stem receiving opening 24. The first clip portion 12 further includes a lip 28 extending upward from the outer facing portion 16 and positioned about the periphery of the first clip portion 12. For example, and without limitation, the lip 28 may have a semicircular cross section projecting from the outer facing portion 16 and extending about the entire periphery of the first clip portion excluding the portion forming the stem receiving channel 26.

The concentric step portions 22 of the first clip portion 12 are adapted and configured to hold stemmed liquid containers. The concentric step portions 22 of the first clip portion 12 are consecutively positioned with increasing depth relative to the outer facing portion 16. For example, and without limitation, the first clip portion 12 includes four concentric step portions. The first step portion 22a extends radially inward towards the stem receiving opening 24. The second step portion 22b extends radially inward from the first step portion 22a towards the stem receiving opening 24. The radially inward side of the second step portion 22b is positioned at a greater depth, relative to the outer facing portion 16, than the radially inward side of the first step portion 22a. The third step portion 22c extends radially inward from the second step portion 22b towards the stem receiving opening 24. The radially inward side of the third step portion 22c is positioned at a greater depth, relative to the outer facing portion 16, than the radially inward side of the second step portion 22b. The fourth step portion 22d extends radially inward from the third step portion 22c towards the stem receiving opening 24. The radially inward side of the fourth step portion 22d is positioned at a greater depth, relative to the outer facing portion 16, than the radially inward side of the third step portion 22c.

With the first clip portion 12 outer facing portion 16 positioned upward, the plurality of concentric step portions 22 are adapted and configured to receive a bowl of a stemmed liquid container (e.g., a wine glass or the like). A typical stemmed liquid container has a bowl which contains the liquid coupled to a stem. The opposite end of the stem is coupled to a base on which the stemmed liquid container typically rests. One step portion of the plurality of step portions 22 supports the bowl of the stemmed liquid container. For example, and without limitation, the bowl portion of a stemmed liquid container rests on the radially inward side of the second step portion 22b. The plurality of concentric step portions 22 allow the holder 10 to support a variety of stemmed liquid containers having various bowl shapes and configurations. For example, and without limitation, a stemmed liquid container having a relatively larger bowl (e.g., a standard red wine glass, a bordeaux glass, a burgundy glass, or the like) may be supported by the first step portion 22a, while a stemmed liquid container having a relatively smaller or narrower bowl (e.g., a champagne flute, a tulip glass, a flute glass, or the like) may be supported by the third step portion 22c. The bowl of the stemmed liquid container rests on one of the plurality of concentric step portions 22 corresponding to the size and configuration of the bowl. The stem of the stemmed liquid container passes through the stem receiving opening 24 while the bowl of the stemmed liquid container is supported by one of the plurality of stepped portions 22.

The concentric step portions 22 are further adapted and configured with decreasing depth such that the concentric step portions 22 bias stemmed liquid containers towards the center of the concentric step portions 22. The centering effect of the concentric step portions 22 directs the stemmed liquid container away from the stem receiving opening 24. This reduces the chance of the stemmed liquid container inadvertently exiting the holder 10 through the stem receiving opening 24.

In some alternative embodiments, the concentric step portions 22 may serve other or additional functions or purposes. For example, and without limitation, the concentric step portions may provide one or more channels for condensate from a liquid container, e.g., a wine glass, supported by the holder 10. Condensate, spilled liquid, or the like may pass into and/or drain out through one or more of the channels formed by concentric step portions 22. This enables a liquid container to be supported above condensate or other liquids that may be otherwise present on or in the holder 10.

The concentric step portions 22 may be generally circular in shape and centered about the stem receiving opening 24. The stem receiving channel 26 extends thought the step portions 22, so the stepped portions 22 are not completely circular leaving a circular segment removed to form the stem receiving channel 26. The circular configuration of the step portions 22 allows the step portions 22 to engage with the circular cross section of the bowl of the stemmed liquid container. The stem receiving opening 24 is a circular opening through the first clip portion 12. In alternative embodiments, the concentric step portions 22 are not circular but rather have an alternative shape or configuration. For example, and without limitation, the concentric step portions 22 are concentric ovals, concentric triangles, concentric squares, concentric rectangles, or the like. In such an embodiment, the bowl of a stemmed liquid container is supported at a plurality of points where one of the step portions 22 tangentially contacts the bowl of the stemmed liquid container. The stem receiving opening 24 may be circular, may have a shape corresponding to the shape of the concentric step portions 22, or may have a shape that differs from the shape of the concentric step portions 22. In alternative embodiments, the first end 18 includes other structures to receive a bowl of a stemmed liquid container. For example, and without limitation, the first end 18 may include a spherical depression or the like through which the stem receiving opening 24 extends. The spherical depression may be spherical or may have a radius which varies with depth. Other alternative structures suitable for supporting a bowl of a stemmed liquid container may be used.

The second clip portion 14 includes an outer facing portion 30 and an inner facing portion 32 opposite the outer facing portion 30. With the second clip portion 14 outer facing portion 30 positioned upward, the second clip portion 14 is adapted and configured to receive a non-stemmed liquid container. The second clip portion 14 further has a first end 34 and a second end 36 opposite the first end 34. The first end 34 includes a circular opening 38 and a stem receiving channel 40. The circular opening 38 is adapted and configured to receive a liquid container. For example and without limitation, the circular opening 38 is sized to accommodate a beverage container such as a cup, can, non-stemmed glass, bottle, or the like. The circular opening 38 may be larger in diameter than the stem receiving opening 24 of the first clip portion 12. The circular opening 38 extends through the second clip portion 14 including the outer facing portion 14. The first end 34 has a stem receiving channel 40. The stem receiving channel 40 is adapted and configured to allow a stem of a liquid container to pass through the first end 34 and into the circular opening 38. For instance, when the first clip portion 12 outer facing portion 16 is positioned upward, the stem of a stemmed liquid container may pass through the stem receiving channel 26 of the first clip portion 12 and the stem receiving channel 40 of the second clip portion 14, and the stem of the stemmed liquid container may pass through the step receiving opening 24 of the first clip portion 12 and the stem circular opening 38 of the second clip portion. The combination of the stem receiving channel 40 and the circular opening 38 result in two elongate and curved arm portions 41 of the second clip portion 14. Each arm portion 41 extends towards the first end 34 and terminates to define the stem receiving channel 40. Each arm portion 41 provides bounds to the lateral movement of a liquid container within the circular opening 38 such that the liquid container cannot be laterally removed from the holder 10. The arm portions 41 maintain the bottom of the liquid container in a lateral position in which the bottom of the liquid container is supported by the inner facing portion 17 of the first clip portion 12. In alternative embodiments, the opening 38 is substantially circular, ovoid, rectangular, triangular, or any other shape.

The second clip portion 14 further includes a lip 42 extending upward from the outer facing portion 30 and positioned about the periphery of the second clip portion 14. For example, and without limitation, the lip 42 may be semicircular in cross section extending outward from the outer facing portion 30 and about the entire periphery of the second clip portion 14 excluding the portion forming the stem receiving channel 40. The lip 42 may extend around the periphery of the second clip portion 14 terminating at either end of the stem receiving channel 40.

In some embodiments, the first clip portion 12 includes a first grip portion 44 and the second clip portion 14 includes a second grip portion 46. The first grip portion 44 extends from the inner facing portion 17 of the first clip portion 12 near the second end 20. The second grip portion 46 extends from the inner facing portion 32 of the second clip portion 14 near the second end 32. Each of the first and second grip portions 44, 46 are adapted and configured to engage with an object such that the holder 10 is releasablely securable to the object. For example, and without limitation, the first and second grip portions 44, 46 may include a plurality of raised segments or serrations, and may be made of a material such as rubber, rubber-like plastic, or the like.

In some embodiments, the first clip portion 12 may include a plurality of ribs 48. The ribs 48 may extend from the inner facing portion 17 of the first clip portion 12. The ribs 48 may be separated radially from one another defining gaps 50 between ribs 48. The ribs 48 may be circular with a central angle which is a reflex angle. The ribs 48 terminate to allow for the stem receiving channel 26. The ribs 48 may be concentric. In alternative embodiments, the ribs 48 have other shapes. For example, and without limitation, the ribs 48 may be square, rectangular, triangular, or other geometric configurations with an opening aligned with the stem receiving channel 26. The ribs 48 may have the same general shape as the stem receiving opening 24 and be concentric with the stem receiving opening 24. The ribs 48 may provide strength, rigidity, reinforcement, or other support to the first clip portion 12. Alternatively, the ribs 48 may serve other or additional functions or purposes. For example, and without limitation, the ribs 48 may provide one or more channels for condensate from a liquid container, e.g., a glass, supported by the holder 10.

In some embodiments, each arm portion 41 of the second clip portion 14 defines a space 43 within the arm portion 41. Vertical portions 45 of each arm portion 41 extend substantially perpendicular to and from the outer facing portion 30 of the second clip portion 14. Each of the arm portions 41 including the vertical portions 45 define the space 43. The vertical portions may 45 provide strength, rigidity, reinforcement, or other support to the second clip portion 14. Alternatively, the vertical portions 45 may serve other or additional functions or purposes.

The first clip portion 12 may include a first pair of flanges 52. Each flange 52 may extend perpendicular to and from the inner facing portion 17 of the first clip portion 12. The second clip portion 14 may include a second pair of flanges 54. Each flange 54 may extend perpendicular to and from the inner facing portion 32 of the second clip portion 14. The first 52 and second 54 pair of flanges may include an opening 56 such that when the flanges are placed adjacent to one another, an axle 58 may pass through the opening. The flanges 52 of the first clip portion 12 pivot about the axle 58 allowing the first clip portion 12 to open and close relative to the second clip portion 14 such that the distance between the second end 20 of the first clip portion 12 and the second end 36 of second clip portion 14 is increased or decreased, respectively. The flanges 54 of the second clip portion 14 pivot about the axle 58 allowing the second clip portion 14 to open and close relative to the first clip portion 12 such that the distance between the second end 36 of the second clip portion 14 and the second end 20 of the first clip portion 12 is increased or decreased, respectively.

The holder 10 further includes a biasing member 60. The biasing member 60 is adapted and configured to bias the second end 20 of the first clip portion 12 towards the second end 36 of the second clip portion 14. The biasing member 60 is a spring coiled about the axle 58 and including portions extending from the axle 58 and being in contact with the inner facing portion 17 of the first clip portion 12 nearer the first end 18 than the second end 20. The biasing member 60 includes a portion extending from the axle 58 that is in contact with the inner facing portion 32 of the second clip portion 14 nearer the first end 34 than the second end 36. In alternative embodiments, biasing member 60 is an otherwise suitable spring or other member adapted and configured to oppose motion of the second end 20 of the first clip portion 12 away from the second end 36 of the second clip portion 14. For example, and without limitation, the biasing member 60 may be or include a coil spring oriented perpendicular to the axle 58, an extension spring coupled to both the first clip portion 12 and the second clip portion 14, a leaf spring, or the like. In still further embodiments, the holder 10 does not include an axle or flanges extending from the first clip portion 12 and the second clip portion 14. For example, and without limitation, the biasing member 60 is an element coupling the first clip portion 12 and the second clip portion 14 such that the second end 20 of the first clip portion 12 is biased towards the second end 36 of the second clip portion 14. The biasing member 60 resists the opening of the first clip portion 12 and second clip portion 14. For example, and without limitation, the biasing member 60 may be or form a portion of a leaf spring.

In operation, a user applies force to the outer facing portion 16 of the first clip portion 12 substantially near the first end 18 and/or the outer facing portion 30 of the second clip portion 14 substantially near the first end 34. As a result, the first clip portion 12 and/or the second clip portion 14 pivot about the axle 58 and the space between the second end 20 of the first clip portion 12 and the second end 36 of the second clip portion 14 is increased. The user orients the holder 10 relative to an object, such as a table top, chair arm, or the like, such that a portion of the object is between the second end 20 of the first clip portion 12 and the second end 36 of the second clip portion 14. The user then reduces the force applied to the outer facing portion 16 of the first clip portion 12 substantially near the first end 18 and/or the outer facing portion 30 of the second clip portion 14 substantially near the first end 34. The reduction in force allows the biasing member 60 to cause the distance between the second end 20 of the first clip portion 12 and the second end 36 of the second clip portion 14 to decrease. The two second ends 20, 36 are in contact with the object and the biasing member 60 applies a force such that the holder 10 is removably coupled to the object. The grip portions 44, 46 may be in contact with the object and facilitate removably coupling the holder 10 to the object.

In orienting the holder 10 relative to the object, the user places the holder 10 with either the first clip portion 12 facing upward or the second clip portion 14 facing upward. This allows a user to configure the holder 10 to hold either a stemmed or stemless container. When positioned with the first clip portion 12 facing upward, the holder 10 is oriented to receive and support a stemmed container. The user inserts the stem of the container into the holder 10 through the stem receiving channel 26 of the first clip portion 12 with the bowl of the stemmed container above the first clip portion 12. Depending on the length of the stem of the container, the stem is inserted through the stem receiving channel 40 of the second clip portion 12 with the base of the container below the second clip portion 14. Alternatively, the base of the container is positioned above the second clip portion 14. The user lowers the container and the bowl of the container is supported by one of the recessed step portions 22. The stem of the container passes through the stem receiving opening 24 and the circular opening 38.

When positioned with the second clip portion 14 facing upward, the holder 10 is oriented to receive and support a stemless container. The user inserts the stemless container into the holder 10 downward through the circular opening 38 of the second clip portion 14. The bottom of the stemless container rests on and is supported by the inner facing portion 17 of the first clip portion 12. For example, and without limitation, the bottom of the stemless container is supported by the ribs 48 of the first clip portion 12.

To release the holder 10, the above steps are reversed. The user removes the container from the holder 10. For the stemless container, the user lifts the container through the circular opening 38 of the second clip portion 14. For the stemmed container, the user lifts the container off the concentric step portions 22 and withdraws the stem from the stem receiving opening 24 and from the stem receiving channel 26 and/or the stem receiving channel 40. The user applies force to the outer facing portion 16 of the first clip portion 12 substantially near the first end 18 and/or the outer facing portion 30 of the second clip portion 14 substantially near the first end 34. As a result, the first clip portion 12 and/or the second clip portion 14 pivot about the axle 58 and the space between the second end 20 of the first clip portion 12 and the second end 36 of the second clip portion 14 is increased. The second end 20 of the first clip portion 12 and/or the second end 36 of the second clip portion 14 move out of contact with the object. The holder 10 is moved such that the object is no longer between the second end 20 of the first clip portion 12 and the second end 36 of the second clip portion 14. The user ceases applying force and the biasing element 60 causes the space between the second end 20 of the first clip portion 12 and the second end 36 of the second clip portion 14 to be reduced. The biasing element 60 can bring the two second ends 20, 36 into contact.

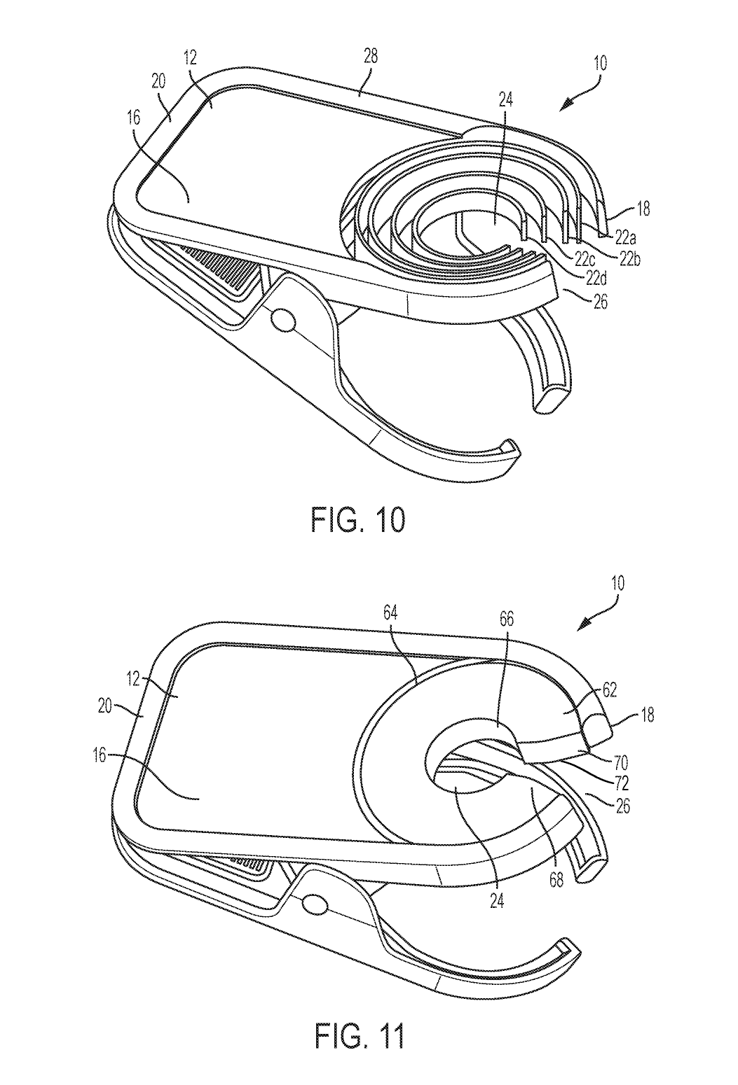

Referring now to FIG. 10, the holder 10 is shown with an alternative embodiment of the concentric step portions 22. In this embodiment, adjacent concentric step portions 22 are separated by a gap. For example, and without limitation, the concentric step portions 22 may be coupled to one another and the first clip portion 12 by one or more flanges, armatures, or the like. Each concentric step portion 22 is a vertical member. Successive concentric step portions 22 have a shorter height. Concentric step portion 22a has a greater height than concentric step portion 22b. Concentric step portion 22b has a greater height than concentric step portion 22c. Concentric step portion 22c has a greater height than concentric step portion 22d. The concentric step portions 22 are aligned with the lower edge of the first clip portion 12 such that successive concentric step portions 22a to 22d are lower relative to the outer facing portion 16 of the first clip portion 12. The concentric step portions 22 function as described with reference to FIGS. 1-9.

Referring now to FIG. 11, the holder 10 is shown with an alternative stemmed glass holding feature. In this embodiment, the first clip portion 12 includes a resilient member 62 adapted and configured to receive a stemmed liquid container. The resilient member 62 is adapted and configured to receive the bowl of the stemmed liquid container and deform into a shape at least partially contouring the bowl of the stemmed liquid container. For example, and without limitation, the resilient member 62 forms a depression under the weight of a liquid container placed onto the resilient member 62. For example, and without limitation, the resilient member 62 is constructed at least in part of a foam rubber, an open cell foam such as polyurethane, a closed cell foam such as neoprene, a rubber, one or more polymers or plastics, or the like.

The resilient member 62 is substantially a circular cylinder, when un-deformed, having a stem receiving opening 24 and a stem receiving opening 26, both of the type described with reference to FIGS. 1-9. The resilient member 62 fits within an inner wall 64 of the first clip portion 12. The resilient member 62 includes a side wall 66 defining the stem receiving opening 24. The resilient member 62 extends circumferentially between a first end 68 and a second end 70. The resilient member 62 has a subtended angle less than three hundred sixty degrees such that the stem receiving channel 26 extends through the resilient member 62. The resilient member 62 is supported by a rigid panel 70 of the first clip portion 12. For example, and without limitation, the rigid panel is integrally formed with the first clip portion 12. The resilient member 62 is secured to the first clip portion 12. For example, and without limitation, the resilient member 62 may be secured to one or more of the rigid panel 70 and the inner wall 64 of the first clip portion 12 by an adhesive. In alternative embodiments, the resilient member 62, inner wall 64, and/or rigid panel 70 may have other shapes and/or configurations.

In view of the foregoing, it will be seen that the several advantages of the disclosure are achieved and attained.

The embodiments were chosen and described in order to best explain the principles of the disclosure and its practical application to thereby enable others skilled in the art to best utilize the disclosure in various embodiments and with various modifications as are suited to the particular use contemplated.

As various modifications could be made in the constructions and methods herein described and illustrated without departing from the scope of the disclosure, it is intended that all matter contained in the foregoing description or shown in the accompanying drawings shall be interpreted as illustrative rather than limiting. For example and without limitation, alternative structures may be used to secure or support drink containers in accordance with this disclosure such that the holder is adapted and configured to hold a container in a first configuration and hold a second container in a second inverted configuration. Thus, the breadth and scope of the present disclosure should not be limited by any of the above-described exemplary embodiments, but should be defined only in accordance with the following claims appended hereto and their equivalents.

1. An apparatus for receiving a liquid container adapted and configured to be removably coupled to an object, the apparatus comprising:
a first clip portion having an outer facing portion and an inner facing portion opposite the outer facing portion, the first clip portion having a first end and a second end opposite the first end, the first end having a plurality of concentric step portions consecutively positioned with increasing depth relative to the outer facing portion, the plurality of concentric step portions extending around a stem receiving opening in the outer facing portion, the first end having a stem receiving channel adapted and configured to allow a stem to pass into the first end and into the stem receiving opening;
a second clip portion having an outer facing portion and an inner facing portion opposite the outer facing portion, the second clip portion having a first end and a second end opposite the first end, the first end of the second clip portion having an opening through the second clip portion, the opening adapted and configured to receive a liquid container, the first end of the second clip portion further having a stem receiving channel adapted and configured to allow a stem to pass into the first end and into the opening;
the first clip portion and the second clip portion pivotally coupled to one another, the second end of the first clip portion biased towards the second end of the second clip portion.

2. An apparatus in accordance with claim 1, wherein the first clip portion stem receiving opening is substantially circular with the plurality of concentric step portions being substantially circular within a plane parallel to the outer facing portion.

3. An apparatus in accordance with claim 1 further comprising a plurality of concentric ribs extending from the inner facing portion of the first clip portion.

4. An apparatus in accordance with claim 1 wherein the first clip portion is adapted and configured to receive a stemmed liquid container having a base coupled to a bowl by a stem in a manner such that when the stem of the container passes through the stem receiving opening and the stem receiving channel, the bowl of the container is supported by at least a portion of the plurality of concentric step portions.

5. An apparatus in accordance with claim 1 wherein the second clip portion is adapted and configured to receive a stemless liquid container in a manner such that when the stemless liquid container passes through the opening, the stemless liquid container is supported by at least a portion of the inner facing portion of the first clip portion.

6. An apparatus in accordance with claim 1 further comprising:
a first pair of flanges perpendicular to the inner facing portion of the first clip portion, each flange of the first pair of flanges extending from the inner facing portion of the first clip portion away from the outer facing portion of the first clip portion;
a second pair of flanges perpendicular to the inner facing portion of the second clip portion, each flange of the second pair of flanges extending from the inner facing portion of the second clip portion away from the outer facing portion of the second clip portion;
an axle extending through the first and second pair of flanges about which the first and second pair of flanges are pivotable; and
a spring coiled around the axle and adapted and configured to bias the second end of the first clip portion towards the second end of the second clip portion.

7. (canceled)

8. (canceled)

9. (canceled)

10. (canceled)

11. (canceled)

12. (canceled)

13. (canceled)

14. An apparatus for receiving a liquid container adapted and configured to be removably coupled to an object, the apparatus comprising:
a first clip portion having an outer facing portion and an inner facing portion opposite the outer facing portion, the first clip portion having a first end and a second end opposite the first end, the first end having a stemmed container receiving member, the stemmed container receiving member extending around a stem receiving opening in the outer facing portion, the first end having a stem receiving channel adapted and configured to allow a stem to pass into the first end and into the stem receiving opening;
a second clip portion having an outer facing portion and an inner facing portion opposite the outer facing portion, the second clip portion having a first end and a second end opposite the first end, the first end of the second clip portion having an opening through the second clip portion, the opening adapted and configured to receive a liquid container, the first end of the second clip portion further having a stem receiving channel adapted and configured to allow a stem to pass into the first end and into the opening;
the first clip portion and the second clip portion pivotally coupled to one another, the second end of the first clip portion biased towards the second end of the second clip portion.

15. An apparatus in accordance with claim 14 wherein the stemmed container receiving member comprises a plurality of concentric step portions consecutively positioned with increasing depth relative to the outer facing portion, the plurality of concentric step portions extending around the stem receiving opening in the outer facing portion.

16. (canceled)

17. (canceled)

18. (canceled)
